(19) United States
(12) Patent Application Publication
(10) Pub. No.: US 2025/0165594 A1
(43) Pub. Date: May 22, 2025

(54) SYSTEM, SYSTEM CONTROL PART, CONTROL METHOD, AND PROGRAM

(71) Applicant: NEC Corporation, Minato-ku, Tokyo (JP)

(72) Inventor: Masaaki KITANO, Tokyo (JP)

(73) Assignee: NEC Corporation, Minato-ku, Tokyo (JP)

(21) Appl. No.: 18/841,410

(22) PCT Filed: Mar. 2, 2022
(86) PCT No.: PCT/JP2022/008869

§ 371 Date: Aug. 26, 2024

(51) Int. Cl. G06F 21/55

(52) U.S. Cl. CPC G06F 21/554; G06F 2221/034

(57) ABSTRACT

A system control part in a system including one or more components and the system control part notifies an instruction of security enhancement to the components when detecting occurrence of a factor that reduces reliability of at least one of the components and notifies an instruction to remove security enhancement to the components when detecting recovery of the component's reliability.

### TECHNICAL FIELD

The present invention relates to a system, a system control part, a control method, and a program.

### BACKGROUND

Patent Literature (PTL) 1 relates to a security device in which a detection part detects an attack on an embedded device, a determination part determines a security risk state, and an embedded control device determines a security function against the attack and can execute the security function.

PTL 2 relates to an authentication system that uses location information to prevent unauthorized authentication in an authentication system that switches from a normal mode to a temporary mode using an alternative portable authentication device when a communication failure occurs between an authentication apparatus and an authentication management server.

PTL 3 relates to a security evaluation system in which each component is evaluated as to a security score and generates a composite security score based on the security scores and a rate of decay measure characterizing a probabilistic security degradation of the system.

PTL 4 relates to patch monitoring and analysis in an industrial process control and automation system.

### CITATION LIST

### Patent Literature

PTL1: Japanese Patent No. 6735952B
PTL2: Japanese Patent Kokai Publication No. JP-P2016-115079A
PTL3: Japanese Patent Kohyo Publication No. JP-P2017-509072A
PTL4: Japanese Patent Kohyo Publication No. JP-P2018-504717A

### SUMMARY

### Technical Problem

The following analysis is provided by the present invention.

When the reliability of a component included in a system decreases, there are fundamental techniques for continuing to operate the system by limiting the performance of the component with reduced reliability, disconnecting the component with reduced reliability from the system, or reconfiguring the system with the remaining components.

In other words, the system has been continuously operated by limiting the communication of the component with reduced reliability, disconnecting the component with reduced reliability, or reconfiguring the system with the remaining components. However, even when the decrease in reliability is not enough degree of certainty to limit the communication of the component or disconnect it, it is only possible to limit the component's performance or disconnect it.

It is an object of the present invention to provide a system, a system control part, a control method, and a program that, even when the reliability of a component included in the system decreases, contribute to allowing for damage control using another component within a system, while keeping the component with reduced reliability continuously operational.

### Solution to Problem

According to a first aspect of the present invention, there can be provided a system comprising one or more components and a system control part, wherein
the system control part notifies an instruction of security enhancement to the components when detecting an occurrence of a factor that reduces reliability of at least one of the components and notifies an instruction to remove security enhancement to the components when detecting a recovery of the component's reliability.

According to a second aspect of the present invention, there can be provided a system control part in a system comprising one or more components and the system control part,
the system control part notifying an instruction of security enhancement to the components when detecting an occurrence of a factor that reduces reliability of at least one of the components and notifying an instruction to remove security enhancement to the components when detecting a recovery of the component's reliability.

According to a third aspect of the present invention, there can be provided a control method, in a system comprising one or more components and a system control part, comprising: performed by the system control part,
a step of notifying an instruction security enhancement to the components when detecting an occurrence of a factor that reduces reliability of at least one of the components: and
a step of notifying an instruction to remove security enhancement to the components when detecting a recovery of the component's reliability.

According to a fourth aspect of the present invention, there can be provided a program, in a system comprising one or more components and the system control part, causing a computer included in the system control part to execute processings of:
notifying an instruction of security enhancement to the component when detecting an occurrence of a factor that reduces reliability of at least one of the components: and
notifying an instruction to remove security enhancement to the component when detecting a recovery of the component's reliability. Further, this program can be stored in a computer-readable storage medium. The storage medium may be a non-transitory one such as a semiconductor memory, a hard disk, a magnetic recording medium, an optical recording medium, and the like. The present invention can also be realized as a computer program product.

### Advantageous Effects of Invention

According to the present invention, there can be provided a system, a system control part, a control method, and a program that, even when the reliability of a component included in the system decreases, contribute to allowing for damage control using another component within a system while keeping the component with reduced reliability continuously operational.

### BRIEF DESCRIPTION OF DRAWINGS

FIG. 1 is a diagram illustrating an example of a schematic configuration of a system according to an example embodiment of the present invention.

FIG. 2 is a diagram illustrating an example of a schematic configuration of a system according to a first example embodiment of the present invention.

FIG. 3 is a diagram illustrating an example of information managed by a system control part according to the first example embodiment of the present invention.

FIG. 4 is a diagram illustrating examples of reliability degradation triggers, factors causing reliability degradation, and reliability recovery triggers for a component according to the first example embodiment of the present invention.

FIG. 5 is a flowchart showing an example of a schematic operation of the system according to the first example embodiment of the present invention.

FIG. 6 is a diagram illustrating an example of a schematic operation of enhancing the security of the system according to the first example embodiment of the present invention.

FIG. 7 is a diagram illustrating another example of the information managed by the system control part according to the first example embodiment of the present invention.

FIG. 8 is a diagram illustrating an example of a schematic operation of removing security enhancement in the system according to the first example embodiment of the present invention.

FIG. 9 is a diagram illustrating another example of the information managed by the system control part according to the first example embodiment of the present invention.

FIG. 10 is a diagram illustrating the configuration of a computer that makes up the system control part according to the present invention.

### EXAMPLE EMBODIMENTS

First, an outline of an exemplary embodiment of the present invention will be described with reference to drawings. In the following outline, reference signs of the drawings are denoted to each element as an example for the sake of convenience to facilitate understanding and is not intended to limit the present invention to the illustrated modes. An individual connection line between blocks in an individual drawing, etc. referred to hereinafter includes both one-way and two-way directions. A one-way arrow schematically illustrates a principal signal (data) flow and does not exclude bidirectionality.

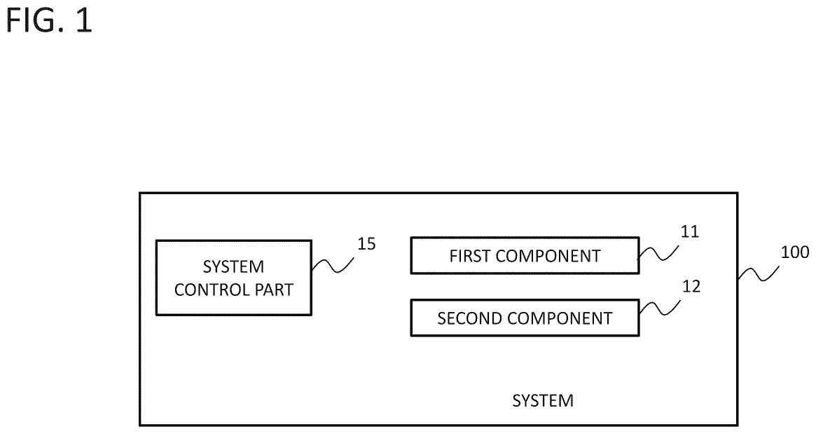

FIG. 1 is a diagram illustrating an example of a schematic configuration of a system according to an example embodiment of the present invention. With reference to FIG. 1, the system 100 includes a first component 11, a second component 12, and a system control part 15. Although FIG. 1 shows two components, the number of components is not limited to two and the system may include one or a plurality of components. Further, a component denotes an element making up the system 100.

The system control part 15 notifies an instruction of security enhancement to the first component 11 and the second component 12 when detecting the occurrence of a factor that reduces the reliability of at least one of the first component 11 and the second component 12. Furthermore, the system control part 15 notifies an instruction to remove security enhancement to the first component 11 and the second component 12 when detecting the recovery of the component's reliability.

According to an example embodiment of the present invention, there can be provided a system that, when the reliability of a component included in the system decreases, contributes to allowing for damage control using another component within a system, while keeping the component with reduced reliability continuously operational.

### First Example Embodiment

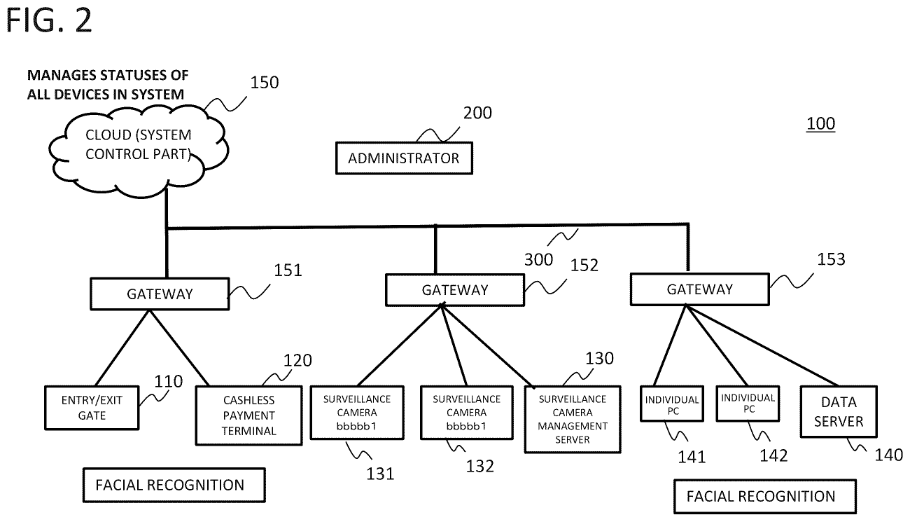

Next, an example of a schematic configuration of a system according to an example embodiment of the present invention will be described with reference to the drawings. FIG. 2 is a diagram illustrating an example of a schematic configuration of a system according to a first example embodiment of the present invention. Note that a component denotes an element making up the system in the description below.

With reference to FIG. 2, the system 100 includes, as a plurality of components, an entry/exit gate 110, a cashless payment terminal 120, a surveillance camera management server (PC (personal computer)) 130, a surveillance camera 131, a surveillance camera 132, a data server 140, an individual (personal computer) PC 141, and an individual PC 141. The entry/exit gate 110 and the cashless payment terminal 120 are connected to a gateway (GW) 151, the surveillance camera management server 130 and the surveillance camera 131 and the surveillance camera 132 are connected to a gateway (GW) 152, and the data server 140, the individual PC 141, and the individual PC 141 are connected to a gateway (GW) 153.

The gateways 151, 152, and 153 are connected to a system control part 150 in the cloud via a network 300. Further, an administrator 200 of the system 100 manages the system 100.

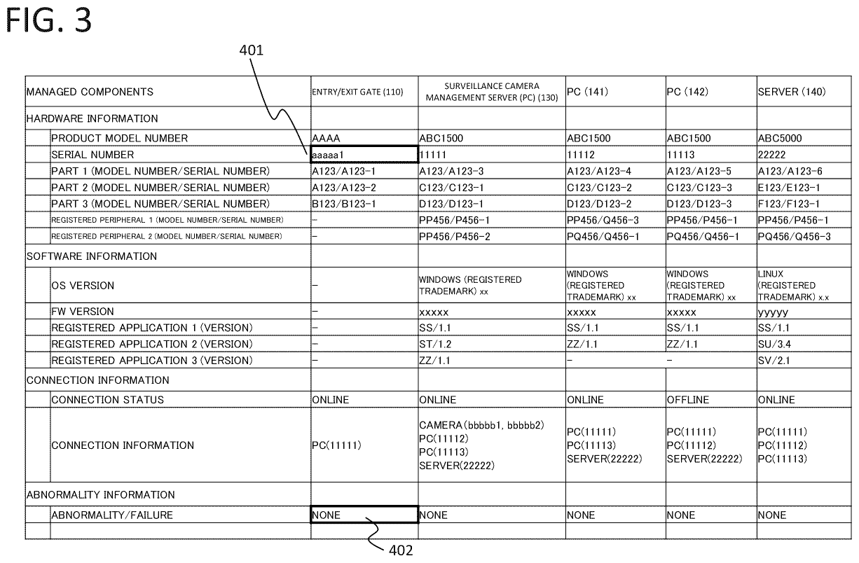

FIG. 3 is a diagram illustrating an example of information managed by the system control part according to the first example embodiment of the present invention. With reference to FIG. 3, the entry/exit gate 110, the surveillance camera management server (PC) 130, the individual PC 141 and the individual PC 142, and the data server 140 shown in FIG. 2 are illustrated as components to be managed. Note that the cashless payment terminal 120 and the surveillance camera 131 and the surveillance camera 132 are omitted. FIG. 3 shows “aaaaa1” in a serial number field 401 of hardware information of the entry/exit gate 110, indicating that the entry/exit gate 110 is currently equipped with hardware having the serial number “aaaaa1.” Meanwhile, an abnormality/failure field 402 of abnormality information of the entry/exit gate 110 indicates that the entry/exit gate 110 currently has no abnormality/failure (“None”).

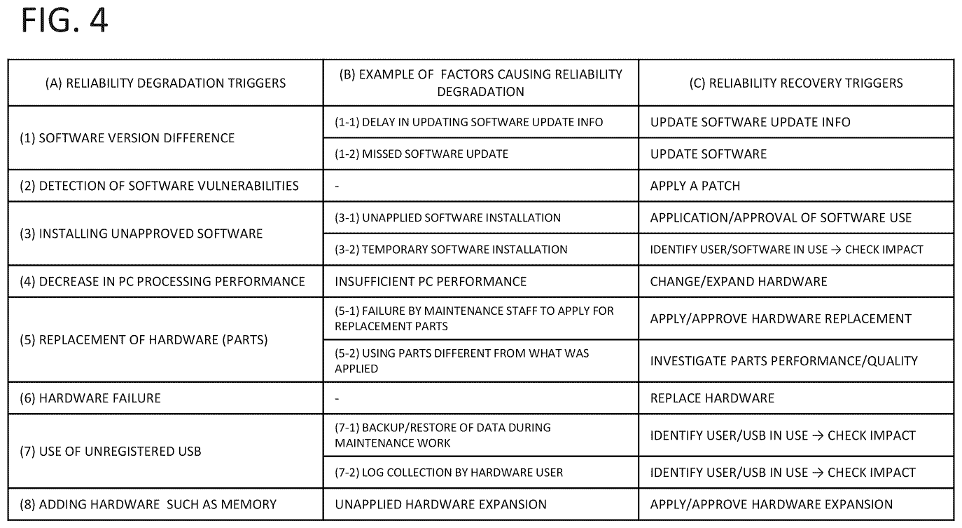

FIG. 4 is a diagram illustrating examples of (A) reliability degradation triggers, (B) factors causing reliability degradation, and (C) reliability recovery triggers for a component in the first example embodiment of the present invention.

As far as the degradation of a component's reliability is concerned, two types of reliability degradation, depending on the application of the component with reduced reliability occur. One is the degradation of the reliability of the component itself in which an abnormality/failure has occurred, and only the components related to the abnormality/failure that has occurred need to have their security enhanced. The second type is when the reliability of other entities (such as people or data) decreases through the component in which an abnormality/failure has occurred, and in this case, it is necessary to enhance the security of all components within the system.

As an example of the degradation of the reliability of a component in which an abnormality/failure has occurred, if the reliability of the PC 141 or the like shown in FIG. 2 decreases, it is necessary to enhance the security of the components on a route that may be attacked from the component in question. In the case where the reliability of the PC 141 decreases, for instance, there are (7) the use (connection) of an unused USB and (2) the detection of software vulnerabilities in (A) the reliability degradation triggers shown in FIG. 4, there is a method to raise the level of the security policy as a security enhancement measure in these cases. Further, (C) reliability recovery triggers in these cases are identifying the user or the USB in use, confirming that there is no impact on the system, and applying a patch.

Further, as another example of the degradation of the reliability of a component in which an abnormality/failure has occurred, if the reliability of the surveillance camera 131 shown in FIG. 2 decreases, it is necessary to enhance the security of the surveillance camera management server 130 that works in conjunction with the surveillance camera 131. As reliability degradation triggers in the case where the reliability of the surveillance camera 131 decreases, for instance, there is (6) a hardware failure in (A) the reliability degradation triggers shown in FIG. 4, such as a camera failure or a decrease in camera image level or the like, and as security enhancement measures, the surveillance camera management server 130 may implement multi-factor authentication such as two-factor authentication, or the secondary use of data may be restricted. Further, (C) reliability recovery triggers in this case are changing hardware such as replacing the camera, identifying the cause of the abnormality/failure, and confirming that there is no impact on the system.

As an example of reduced reliability of other entities (such as people or data) via a component in which an abnormality/failure has occurred, if the reliability of the entry/exit gate 110 decreases, the reliability of people who enter through the entry/exit gate 110 is determined to have declined, and the security of the entire system 100 must be enhanced. For instance, as to the entry/exit gate 110, there are a malfunction due to a component failure, a communication failure, and a decrease in camera image level or the like as illustrated in (6) a hardware failure of (A) the reliability degradation triggers shown in FIG. 4. Further, as security enhancement measures, the PCs 141 and 142 and the cashless payment terminal 120 may implements multi-factor authentication such as two-factor authentication, or the monitoring of suspicious individuals using the surveillance cameras 131 and 132 may be strengthened. In addition, (C) reliability recovery triggers in this case are changing hardware such as replacing a faulty component, identifying the cause of the failure, and confirming that there is no impact on the system, and so on.

As another example of the reliability of other entities (such as people or data) reduced through a faulty component, if the reliability of hardware (HW) on a communication path, such as a switch, decreases, the reliability of data that goes through the hardware is determined to have declined, and the security of the entire system 100 is necessary to be enhanced. In this case, for instance, there are (5) replacement with (unapplied or unapproved) hardware (parts) and (1) a software version difference due to a missed or delayed update in (A) the reliability degradation triggers shown in FIG. 4. Further, as a security enhancement measure, there is a method in which signatures may be attached to all data in order to enhance data reliability. In addition, as (C) reliability recovery triggers, there are methods to replace hardware or update software.

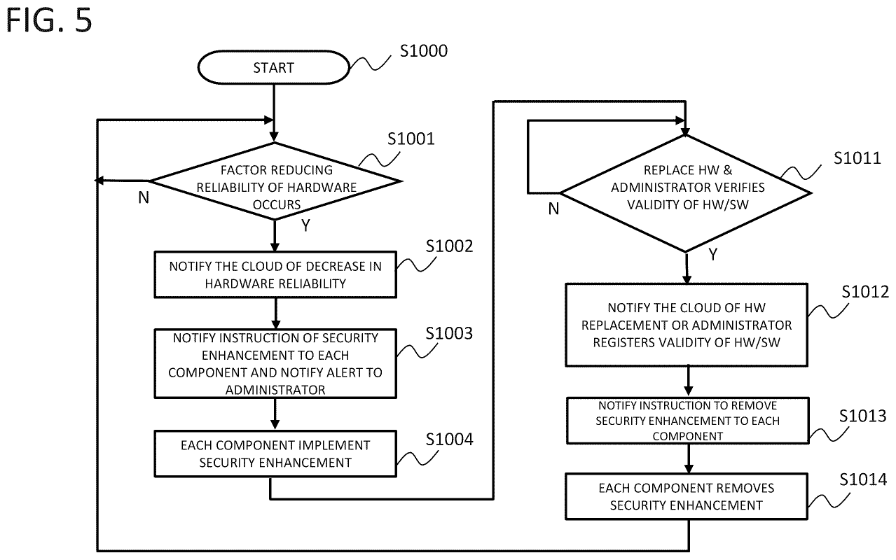

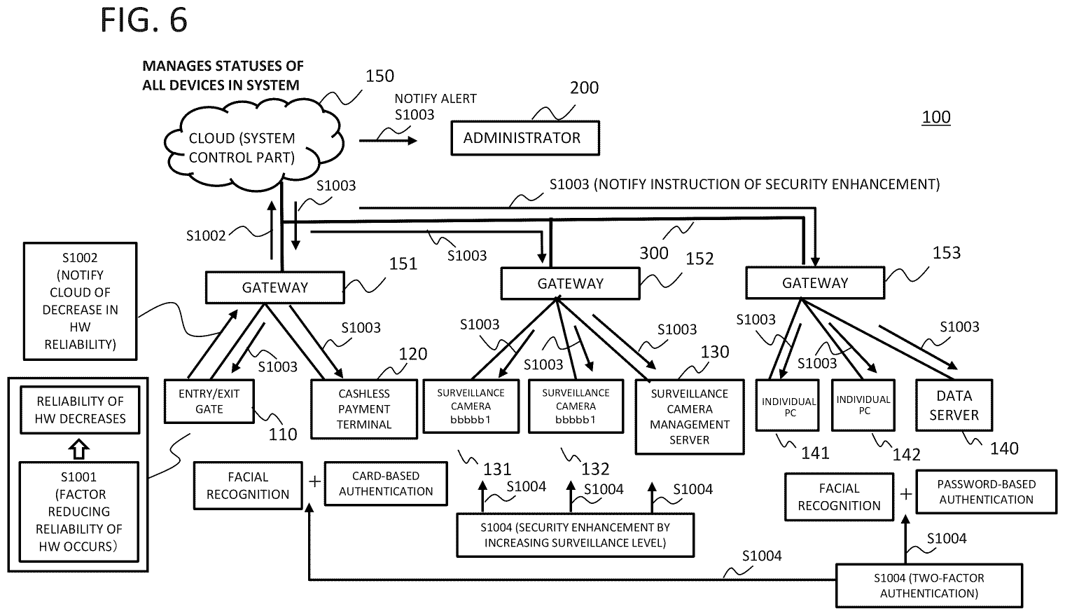

Next, the following describes an example of a schematic operation of enhancing the security of the system according to the first example embodiment of the present invention. FIG. 5 is a flowchart showing an example of a schematic operation of the system 100 according to the first example embodiment of the present invention. Moreover, FIG. 6 is a diagram illustrating an example of a schematic operation of enhancing the security of the system according to the first example embodiment of the present invention. The schematic operation of enhancing the security of the system according to the first example embodiment of the present invention will be described using FIGS. 5 and 6.

With reference to FIG. 5, the operation of the system 100 starts in step S1000. Next, in step S1001, the system control part 150 in the cloud monitors whether or not a factor that reduces the reliability of hardware occurs.

As an operation when the reliability of a component decreases, for instance, due to a hardware failure of the entry/exit gate 110 shown in FIG. 6 or a decrease in camera image level, a factor reducing the reliability of the entry/exit gate 110 occurs such as (6) a hardware failure among (A) the reliability degradation triggers shown in FIG. 4. In other words, a factor reducing the reliability occurs at the entry/exit gate 110 in FIG. 6, and the reliability of the hardware decreases.

When the entry/exit gate 110 detects the occurrence of the factor reducing the reliability of the hardware thereof such as a malfunction of the entry/exit gate 110 in the step S1001 in FIG. 5, the entry/exit gate 110 automatically notifies the system control part 150 in the cloud of the occurrence of the factor reducing the reliability of the hardware via the gateway 151 shown in FIG. 6 in step S1002.

Alternatively, if the gateway 151 in FIG. 6 detects the occurrence of a factor that reduces the reliability of hardware such as a malfunction of the entry/exit gate 110, the gateway 151 may automatically notify the system control part 150 in the cloud of the occurrence of the factor that reduces the reliability of hardware in the step S1002 in FIG. 5.

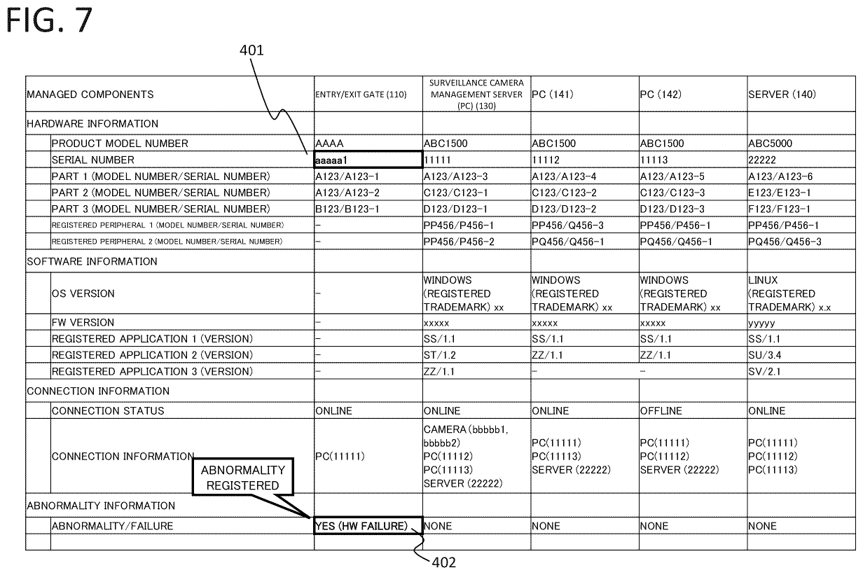

FIG. 7 is a diagram illustrating another example of the information managed by the system control part 150 of the first example embodiment of the present invention. With reference to FIG. 7, upon receiving the notification that a factor that reduces the reliability of hardware has occurred, the system control part 150 in the cloud registers the abnormality by writing “Yes (hardware failure)” in the abnormality/failure field 402 of the abnormality information in the information managed thereby. In this case, aaaaa1 of the currently installed hardware is written in the serial number field 401 of the hardware information of the entry/exit gate 110.

Next, in step S1003 in FIG. 5, triggered by the fact that “Yes (hardware failure)” was written in the abnormality/failure field 402 of the abnormality information, the system control part 150 in the cloud notifies an instruction of security enhancement to each component. At this time, an alert indicating the reduced reliability of the entry/exit gate may be sent to the administrator 200.

In other words, as indicated by the step S1003 in FIG. 6, the system control part 150 in the cloud notifies an instruction of security enhancement to the entry/exit gate 110, the cashless payment terminal 120, the surveillance camera management server 130, the surveillance cameras 131 and 132, the data server 140, and the individual PCs 141 and 142 in the step S1003.

Next, in step S1004 in FIG. 5, each component enhances security. In other words, as indicated by the step S1004 in FIG. 6, the entry/exit gate 110 and the cashless payment terminal 120 implement multi-factor authentication such as two-factor authentication using card-based authentication in addition to facial recognition, the surveillance camera management server 130 and the surveillance cameras 131 and 132 enhance security by increasing the surveillance level, and the data server 140 and the individual PCs 141 and 142 implement multi-factor authentication such as two-factor authentication using password-based authentication in addition to facial recognition. Note that, since it is possible to visually confirm to be changed to the implementation of two-factor authentication, a user is able to recognize that the reliability of the system 100 is decreasing.

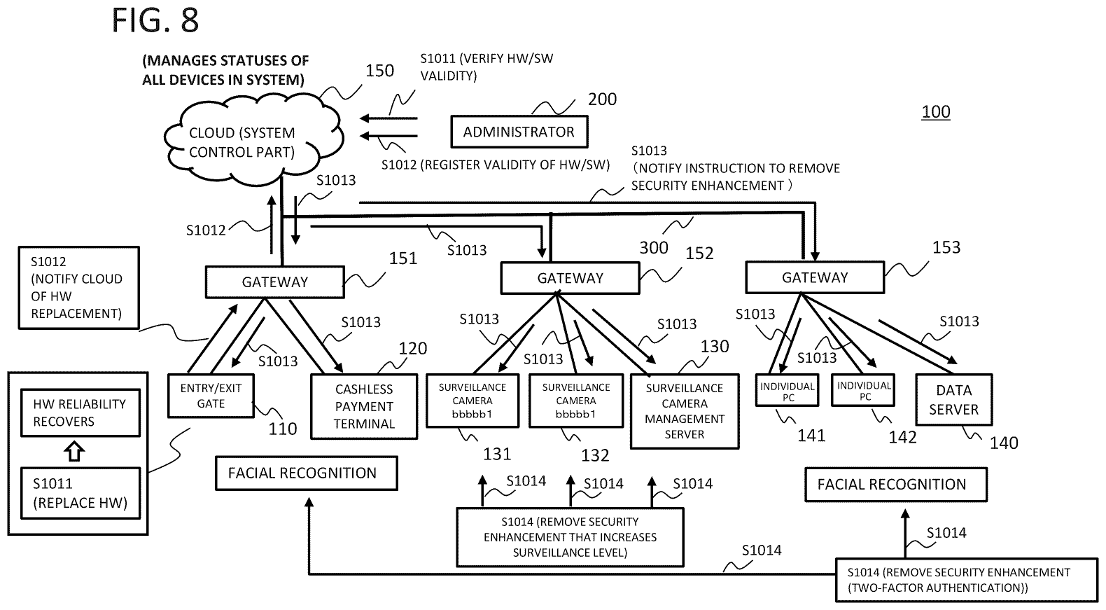

Next, the following describes an example of a schematic operation of removing security enhancement in the system of the first example embodiment of the present invention. FIG. 5 is a flowchart showing an example of a schematic operation of the system 100 according to the first example embodiment of the present invention. Further, FIG. 8 is a diagram illustrating an example of a schematic operation of removing security enhancement in the system of the first example embodiment of the present invention. The schematic operation of removing security enhancement in the system according to the first example embodiment of the present invention will be described using FIGS. 5 and 8.

In step 1011 shown in FIG. 5, it is monitored whether or not the reliability of a component recovers, i.e., whether or not the hardware is replaced, or whether or not the administrator 200 verifies the validity of the hardware/software. For instance, in the step S1011 in FIG. 8, if the hardware of the entry/exit gate 110 is replaced, the reliability of the hardware of the entry/exit gate 110 recovers.

Further, in the step 1011 in FIG. 5, the administrator 200 verifies the state of hardware/software and confirms the validity of hardware/software to the system control part 150 in the cloud if it is determined that there is no problem. When the replacement of the faulty hardware of the entry/exit gate 110 is thus notified to the system control part 150 in the cloud, the reliability of the hardware of the entry/exit gate 110 is determined to recover.

Next, in step S1012 in FIG. 5, when the entry/exit gate 110 shown in FIG. 8 detects the change (replacement) of the faulty hardware, the entry/exit gate 110 notifies the system control part 150 in the cloud of the replacement of the faulty hardware.

Alternatively, if the gateway 151 in FIG. 8 detects the replacement of the faulty hardware of the entry/exit gate 110, the gateway 151 may automatically notify the system control part 150 in the cloud of the replacement of the faulty hardware of the entry/exit gate 110 in the step S1012 in FIG. 5.

Further, in the step S1012 in FIG. 5, the administrator 200 may register the validity of hardware/software.

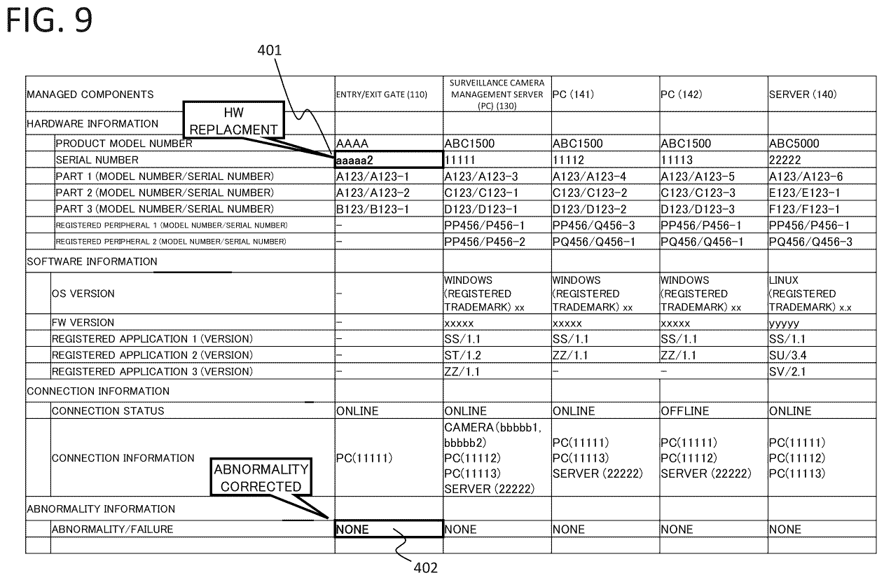

FIG. 9 is a diagram illustrating another example of the information managed by the system control part 150 of the first example embodiment of the present invention. With reference to FIG. 9, upon receiving the notification, the system control part 150 in the cloud writes the serial number aaaaa2 of the new hardware installed as a result of the hardware replacement in the serial number field 401 of the hardware information of the entry/exit gate 110 in the information managed thereby and indicates that the abnormality has been corrected by writing “None” in the abnormality/failure field 402 of the abnormality information in the information managed thereby.

Next, in step S1013 in FIG. 5, triggered by the fact that “None” was written in the abnormality/failure field 402 of the abnormality information, the system control part 150 in the cloud notifies an instruction to remove security enhancement to each component.

In other words, as indicated by the step S1013 in FIG. 8, the system control part 150 in the cloud notifies an instruction to remove security enhancement to the entry/exit gate 110, the cashless payment terminal 120, the surveillance camera management server 130, the surveillance cameras 131 and 132, the data server 140, and the individual PCs 141 and 142.

Next, in step S1014 in FIG. 5, each component removes the security enhancement thereof. As indicated by the step S1014 in FIG. 8, the entry/exit gate 110 and the cashless payment terminal 120 disable multi-factor authentication such as two-factor authentication using facial recognition and card-based authentication and use only facial recognition, the surveillance camera management server 130 and the surveillance cameras 131 and 132 disable the security enhancement that increases the surveillance level, and the data server 140 and the individual PCs 141 and 142 disable multi-factor authentication such as two-factor authentication using facial recognition and password-based authentication and use only facial recognition. Note that, since it is possible to visually confirm the disablement of two-factor authentication, a user is able to recognize that the reliability of the system 100 has recovered.

According to the first example embodiment of the present invention, there can be provided a system that, even when the reliability of a component included in the system decreases, contributes to allowing for damage control using another component within a system while keeping the component with reduced reliability continuously operational. Further, there can be provided a system that contributes to enabling a component within the system to immediately remove damage control when a reduced reliability of another component recovers.

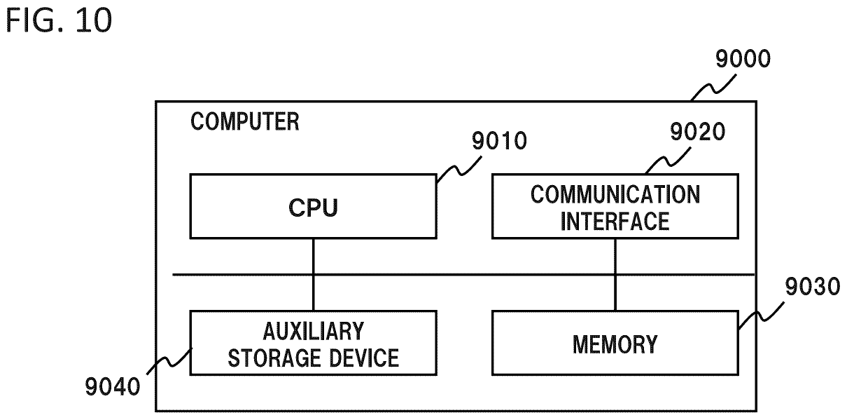

Further, the procedures described in an example embodiment and the first example embodiment above can be realized by a program causing a computer (9000 in FIG. 10) that functions as the system control part 150 to realize the functions of the system control part 150. FIG. 10 illustrates, as an example, such a computer configured to comprise a CPU (Central Processing Unit) 9010, a communication interface 9020, a memory 9030, and an auxiliary storage device 9040. In other words, the CPU 9010 in FIG. 10 executes the program, updating each calculation parameter held by the auxiliary storage device 9040.

The memory 9030 is a RAM (Random Access Memory), a ROM (Read-Only Memory), and so on.

In other words, each part (each processing means or function) of the system described in an example embodiment and the first example embodiment above can be realized by a computer program causing the processor of the computer to execute each of the processes described above using the hardware thereof.

Finally, preferred modes of the present invention will be summarized.

### Mode 1

(Refer to the system according to the first aspect.)

### Mode 2

In the system according to Mode 1,
it is preferable that the component for which the occurrence of the factor that reduces the reliability thereof has been detected continues operation thereof during a period in which the factor that reduces the reliability persists, and that each of the components that has received the notification of the instruction of security enhancement implement the security enhancement.

### Mode 3

In the system according to Mode 2,
it is preferable that the security enhancement implemented by the component includes multi-factor authentication.

### Mode 4

In the system according to Modes 1 to 3,
it is preferable that each of the components that has received the notification of an instruction to remove security enhancement remove the security enhancement.

### Mode 5

(Refer to the system control part according to the second aspect.)

### Mode 6

(Refer to the control method according to the third aspect.)

### Mode 7

It is preferable that the control method according to Mode 6 include:
a step during which the component for which the occurrence of the factor that reduces the reliability thereof has been detected continues operation thereof during a period in which the factor that reduces the reliability persists; and
a step during which each of the components that has received the notification of the instruction of security enhancement implements the security enhancement.

### Mode 8

In the control method according to Mode 7,
it is preferable that the step during which the component implements the security enhancement includes implementing multi-factor authentication.

### Mode 9

(Refer to the program according to the fourth aspect.)

### Mode 10

It is preferable that the program according to Mode 9 causes a computer included in the component for which the occurrence of the factor that reduces the reliability thereof has been detected to execute a processing of continuing operation thereof during a period in which the factor that reduces the reliability persists, and causes a computer included in each of the components that has received the notification of the instruction of security enhancement to execute a processing of implementing the security enhancement.

Further, Mode 5 can be expanded into Modes 1 to 4. As Modes 1 to 3, Modes 6 to 8 can be expanded into Mode 4. As Modes 1 and 2, Modes 9 and 10 can be expanded into Modes 3 and 4.

Further, the disclosure of each Patent Literature cited above is incorporated herein in its entirety by reference thereto. It is to be noted that it is possible to modify or adjust the example embodiments or examples within the scope of the whole disclosure of the present invention (including the Claims) and based on the basic technical concept thereof. Further, it is possible to variously combine or select a wide variety of the disclosed elements (including the individual elements of the individual claims, the individual elements of the individual example embodiments or examples, and the individual elements of the individual figures) within the scope of the disclosure of the present invention. Namely, the present invention of course includes various variations and modifications that could be made by those skilled in the art according to the overall disclosure including the claims and the technical concept. In particular, with respect to the numerical ranges described herein, any numerical values or small range(s) included in the ranges should be construed as being expressly described even if not particularly mentioned.

### REFERENCE SIGNS LIST

11: first component
12: second component
15: system control part
100: system
110: entry/exit gate
120: cashless payment terminal
130: surveillance camera management server (PC (personal computer))
131, 132: surveillance camera
140: data server
141, 142: individual PC (personal computer)
151, 152, 153: gateway (GW)
9000: computer
9010: CPU
9020: communication interface
9030: memory
9040: auxiliary storage device

What is claimed is:

1. A system comprising one or more components and a system control part, comprising:
at least a processor; and
a memory in circuit communication with the processor,
wherein the processor is configured to execute program instructions stored in the memory to perform:
notifying an instruction of security enhancement to the components when detecting an occurrence of a factor that reduces reliability of at least one of the components, and
notifying an instruction to remove security enhancement to the components when detecting a recovery of the component's reliability.

2. The system according to claim 1, wherein
the component for which the occurrence of the factor that reduces the reliability thereof has been detected continues operation thereof during a period in which the factor that reduces the reliability persists, and
each of the components that has received the notification of the instruction of security enhancement implements the security enhancement.

3. The system according to claim 2, wherein the security enhancement implemented by the component includes multi-factor authentication.

4. The system according to claim 1, wherein
each of the components that has received the notification of an instruction to remove security enhancement removes the security enhancement.

5. A system control part in a system comprising one or more components and the system control part,
the system control part comprising:
at least a processor; and
a memory in circuit communication with the processor,
wherein the processor is configured to execute program instructions stored in the memory to perform:
notifying an instruction of security enhancement to the components when detecting an occurrence of a factor that reduces reliability of at least one of the components, and
notifying an instruction to remove security enhancement to the components when detecting a recovery of the component's reliability.

6. A control method, in a system comprising one or more components and a system control part, comprising: performed by the system control part,
notifying an instruction security enhancement to the components when detecting an occurrence of a factor that reduces reliability of at least one of the components; and
notifying an instruction to remove security enhancement to the components when detecting a recovery of the component's reliability.

7. The control method according to claim 6, wherein
the component for which the occurrence of the factor that reduces the reliability thereof has been detected continues operation thereof during a period in which the factor that reduces the reliability persists; and
each of the components that has received the notification of the instruction of security enhancement implements the security enhancement.

8. The control method according to claim 7, wherein the component's implementing the security enhancement includes implementing multi-factor authentication.

9. A computer-readable non-transitory recording medium recording a program, the program, in a system comprising one or more components and the system control part, causing a computer included in the system control part to execute processings of:
notifying an instruction of security enhancement to the component when detecting an occurrence of a factor that reduces reliability of at least one of the components; and
notifying an instruction to remove security enhancement to the component when detecting a recovery of the component's reliability.

10. The medium according to claim 9, the program
causing a computer included in the component for which the occurrence of the factor that reduces the reliability thereof has been detected to execute a processing of continuing operation thereof during a period in which the factor that reduces the reliability persists, and
causing a computer included in each of the components that has received the notification of the instruction of security enhancement to execute a processing of implementing the security enhancement.

11. The system control part according to claim 5, wherein
the component for which the occurrence of the factor that reduces the reliability thereof has been detected continues operation thereof during a period in which the factor that reduces the reliability persists, and
each of the components that has received the notification of the instruction of security enhancement implements the security enhancement.

12. The system control part according to claim 11, wherein the security enhancement implemented by the component includes multi-factor authentication.

13. The system control part according to claim 5, wherein
each of the components that has received the notification of an instruction to remove security enhancement removes the security enhancement.

14. The control method according to claim 6, wherein
each of the components that has received the notification of an instruction to remove security enhancement removes the security enhancement.
